(19) United States
(12) Patent Application Publication
(10) Pub. No.: US 2009/0252566 A1
(43) Pub. Date: Oct. 8, 2009

(54) CUTTING INSERT

(75) Inventor: Gerald Minshall, Warwickshire (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: KENNAMETAL INC., Latrobe, PA (US)

(21) Appl. No.: 12/278,014

(22) PCT Filed: Feb. 1, 2007
(86) PCT No.: PCT/GB07/00323

§ 371 Date: Oct. 16, 2008

(30) Foreign Application Priority Data
Feb. 2, 2006 (GB) 0602067.1

(51) Int. Cl. B23B 27/16; B23D 77/02

(52) U.S. Cl. 407/102; 407/119; 407/113; 29/525.11

(57) ABSTRACT

A cutting insert (20) for a machine tool comprising a flat blade formed from polycrystalline diamond material and having a front face (21) thereon formed from the PCD phase (23) with at least one cutting edge (22) thereon, and a rear face formed from the second phase substrate (24), the rear face having serrations (25) therein formed within the second phase substrate (24), preferably substantially normal to each cutting edge.

### FIELD

This invention relates to cutting inserts for machine tools such as reamers and borers and to a method of securing a cutting insert to a machine tool.

### BACKGROUND OF THE INVENTION

Diamond is the hardest, and therefore, the most abrasion resistant of all materials and some cutting tips or blade edges for machine tools are formed from diamond powder which may be formed into polycrystalline diamond (PCD) which is extremely hard and has good abrasion resistance as compared with carbide cutting tools.

PCD is a composite of individual diamond crystals sintered together in an inter-connected network. The PCD crystals may be sintered directly onto a cutting tool such as a rotary cutter as is shown in EPO 0528243A.

PCD is also available in round blanks comprising a first phase of PCD formed a second phase of sintered tungsten carbide. The blanks are made by applying ultra high pressure and a high temperature to a layer of diamond powder on a bed of a metal carbide, nitride or carbonitride powder substrate. The metallic second phase infiltrates from the cemented carbide substrate into the interstitial regions between diamond crystals during the process and bonds the diamonds together. The resultant blank combines an extremely hard PCD surface bonded to a carbide substrate. All this is described in GB 2408735-A.

PCD blanks are very expensive and the PCD blank is then typically cut into a number of small portions which may be mounted directly onto cutting tools by brazing as is shown in whole tool must be discarded or factory serviced once the PCD tool tip is worn or damaged.

A further disadvantage of the PCD blank material is that the material is relatively brittle and may break if subjected to tool clamping loads. In another development a run cool tip is welded or brazed on a supporting body which in turn is secured to a tool head by mechanical means. This arrangement insert and also permits the interchange of the insert. Such an insert is available from the present applicants.

Another known insert is shown in DE 4423 861 which discloses a cutting insert having PCD tips brazed onto a body and which is re-orientatable in the tool allowing each tip to be used in turn.

The welding or brazing of PCD tips onto a supporting body is an expensive operation and the tips must be accurately ground after the welding process.

### OBJECT OF THE PRESENT INVENTION

The present invention seeks to provide an improved and more economically manufactured PCD cutting insert for a machine tool.

### STATEMENTS OF INVENTION

According to the invention there is provided a cutting insert for a machine tool comprising a flat blade formed from polycrystalline diamond material and having a front face formed from the PCD phase with at least one cutting edge thereon, and a rear face formed from the second phase substrate, and a rear face having therein at least on groove extending normal to each cutting edge, the groove being formed within the second phase substrate.

Preferably the groove is one of a plurality of serrations formed in the substrate.

The blade may have between two to four cutting edges, and is preferably square, or substantially square, preferably having four cutting edges and the rear of the blade is provided with two sets of intersecting serrations.

The serrations may have many different forms including symmetrical wave form such as sinusoidal waves, zig-zag forms, corrugations, and non symmetrical serrations.

Also according to the invention there is provided a cutting tool comprising a body having a recess therein with a blade according to a first aspect of the invention mounted therein, each groove on the rear of the blade mutually inter-engaging with a co-operating ridges or ridges on the tool to secure the blade against machining loads.

Preferably the ridges extend across the full width of the blade and the cutting blade is adjustably positioned along the ridge(s) by means of a single screw threaded adjuster. The inter-engaging groove and ridge prevent the blade from tipping during adjustment.

The ridges on the tool may be formed as a series of serrations, and the serrations on the tool can be formed on a face of the recess, or alternatively on a removable carrier which is mounted in the recess.

The blade is secured to said face by the head of a clamping screw or a clamp down plate However, the clamping load can be relatively low since the machining loads are taken by the inter-engaging groove(s) and ridge(s).

With a square blade, having sets of intersecting serrations on the rear face, each of the four cutting edges can be utilised by unclamping the blade to release the interengaging serrations and then rotating the blade as desired and re-engaging the serrations.

There is further provided a method of securing a PCD material cutting blade in a cutting tool, the cutting blade having at least one cutting edge formed on the PCD face of the blade, wherein the cutting blade is provided with at least one groove in formed in the PCD second phase substrate on its rear face, and the cutting blade is clamped against a mutually inter-engagable ridge provided on the tool.

Preferably, a groove(s) is provided substantially normal to each cutting edge, with the cutting edge of the blade being adjusted to a new position by movement of the blade along a ridge or ridges provided on the tool.

If the blade has a plurality of cutting edges, the blade edge can be changed or the blade changed, simply by removing the blade from the carrier and relocating said blade, or another identical blade on the serrations or ridges, to provide a new cutting edge, with the mutually inter-engaging grooves and ridges ensuring re-alignment of said cutting edge.

### DESCRIPTION OF DRAWINGS

FIG. 1 is a plan view of a prior art cutting insert,

FIG. 2 is an isometric view of a cutting insert according to the present invention,

FIG. 3 is an end view of the cutting insert shown in FIG. 2,

FIG. 4 is a plan view of the cutting blade of FIG. 2 showing the PCD surface,

FIG. 5 is a schematic radial section through a cutting tool showing the cutting insert in situ, and

FIG. 6 is a side view of the tool shown in FIG. 5.

### DETAILED DESCRIPTION OF THE INVENTION

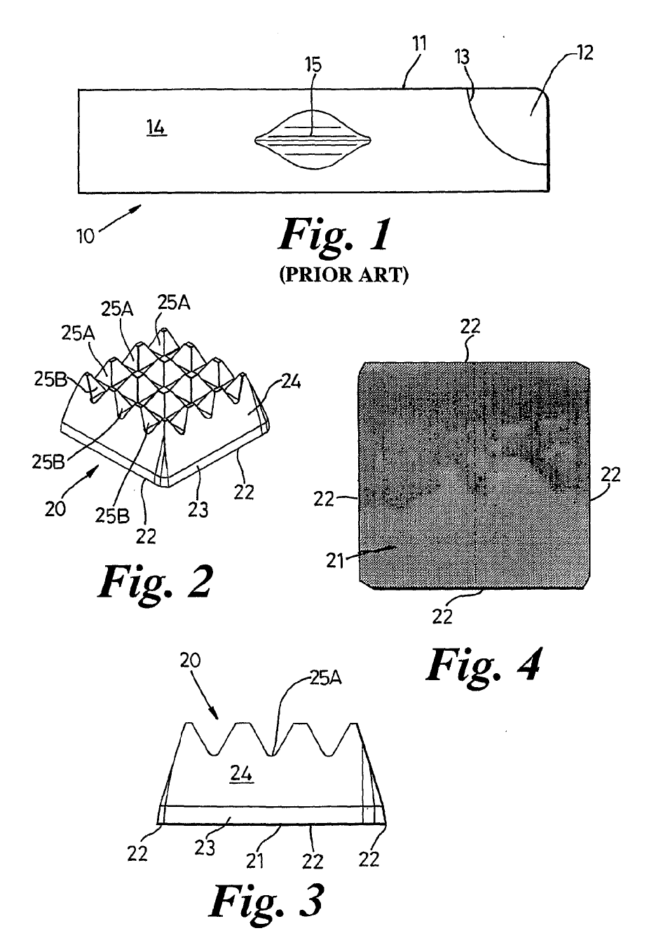

A prior art cutting blade or insert 10 is shown in FIG. 1 and has tungsten carbide body 11 which is substantially rectangular in plan. The front face 14 of the insert has a depression 15, or dimple, formed therein Which is located symmetrically about the approximate mid-length centre line and the mid width centre line of the face 14. The depression is utilised in the clamping of the insert 10 into a tool as is described in detail in GB 2 338 196.

A PCD cutting tip 12 is brazed into a pocket 13 formed in the tungsten carbide body 11.

With reference now to FIGS. 2 to 4 in particular, there is shown a cutting insert or blade 20 according to the present invention. The insert 20 is cut from a PCD blank having a PCD phase 23 formed on a carbide substrate 24, using an electro discharge wire cutting process. The insert 20 is a substantially square planar shape having a flat front face 21 on the PCD phase with at least two, and preferably four cutting edges 22 formed thereon. The PCD phase generally has a thickness of 0.45-0.7 mm depending upon the size of the diamond grains. The carbide substrate 24 forms the rear of the insert 20 and is typically between 0.55-2.6 mm in thickness. For the present embodiment the PCD phase 23 is about 0.7 mm in thickness and the carbide substrate is between 1.3 & 2.6 mm in thickness.

The rear of the insert 20 is provided with at least one groove 25 in the rear surface, and preferably with a plurality of serrations 35 thereon. The serrations 25 comprise serrations which extend substantially normal to the cutting edges 24 for the full length of the blade 16. In the present example with four cutting edges 34 one set of serrations 25A extends transversely of the other set of serrations 25B so that the serrations 25A & 25B intersect each other forming separate pyramidal projections. The serrations typically have a depth of 0.85 mm and are ground into the substrate by means of a formed diamond grinding wheel and are located entirely within the carbide second phase substrate 24.

With two cutting edges on opposite sides of the blade, the serrations 25 extend only between said opposite sides.

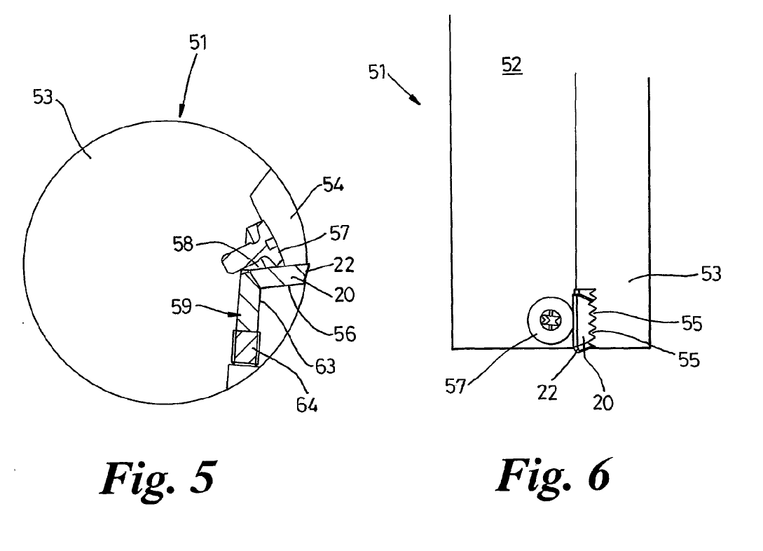

With reference to FIGS. 5 and 6 of the drawings, there is shown a tool 51 having a shank 52 which in use is clamped into a machine tool for rotation of the tool about its longitudinal axis.

The tool 51, which is typically a reamer, has a cylindrical head 53 which carries at least one cutting insert 20. The head 53 is typically provided with a plurality of cutting inserts 20 at angularly spaced locations around the head 13, and only one of which is shown for the sake of simplicity and the invention will be described in detail with reference to said one blade only, any other blade being substantially identical.

Each insert 20 is arranged in a respective recess 54 located in the periphery of the head 53. The head 53 may also have a plurality of axially extending centering pads (not shown) spaced around the head. If two inserts 20 are utilised these may be arranged diametrically opposite each other.

The cutting insert 20 is oriented radially of the head 53. The recess 54 has a radial side face 56 against which a cutting insert is secured by a clamping screw 57.

The serrations 25 on the rear of the insert inter-engage with like radial serrations 55 on the radial side face 56 of the recess 54. In this example, the serrations 25 & 55 are in the form of flat sided straight ribs of triangular cross-section with the included angle at the apex being between 45-90° of arc, preferably about 60° of arc. The serrations have a pitch of between 1.00 mm and 1.75 mm, and the tops of the ribs are chamfered. An axially extending clearance hole 58 is provided at the intersection of the side face 56 of the recess 54, and the radially inner side of the recess.

The insert 20 is held in the recess by the screw 57 which presses the insert 20 so that the serrations 25 & 55 are hard in abutment with each other, so that any loads on the blade are transmitted to the tool head 53 through the interengaged serrations.

The inner facing side of the insert abuts against at least one adjuster 59. Each adjuster 59 comprises a tapered wedge which is moveable in a chordal bore 63, by means of an adjuster screw 64 for radial adjustment of the height of the cutting edge 22. The total adjustment range will be about 0.5 mm.

When an insert is first fitted to a tool, the insert is set to the correct radial adjustment by the conventional trial and error technique by adjustment of position of the insert. The blade is typically set to an accuracy of between 3-5 microns. Thereafter if it is desired to renew the cutting edge 22, the insert 20 is removed from the notch 22 by unscrewing of the clamping screw 57. The insert 20 is then re-positioned to provide a new edge, or replaced by a new identical blade. Since the serrations 25 on the back face of any blade are precision ground therein relative to the cutting edge(s) the new blade when fitted to the reamer will provide an accurately axially positioned cutting edge and therefore needs only to be radially adjusted.

The insert 20 may be mounted on a removable carrier (not shown) and the assembled insert 20 and carrier are secured in the respective recess 54.

Typical machine tools on which the inserts 20 may be used are borers, reamers, milling heads etc.

1-12. (canceled)

13. A cutting insert for a machine tool comprising a flat blade formed from polycrystalline diamond (PCD) material and having a front face thereon formed from the PCD phase with at least one cutting edge thereon, and a rear face formed from the second phase substrate, the rear face having therein at least one groove therein formed within the second phase substrate.

14. An insert as claimed in claim 13, wherein at least one groove is provided in the rear face substantially normal to each cutting edge.

15. An insert as claimed in claim 13 wherein each groove is one of a plurality of serrations formed in the substrate.

16. An insert as claimed in claim 13 wherein the insert has between two to four cutting edges.

17. An insert as claimed in claim 16 wherein the insert is substantially square with four cutting edges and the rear of the blade is provided with two sets of intersecting serrations.

18. A cutting tool comprising:
a body having a recess therein with an insert mounted therein, said insert comprising a flat blade formed from a polycrystalline diamond (PCD) material and having a front face thereon formed from the PCD phase with at least one cutting edge thereon, and a rear face formed from the second phase substrate, the rear face having therein at least one groove therein formed within the second phase substrate; and
wherein each of said at least one groove on the rear of the insert mutually inter-engages with a co-operating ridge or ridges on the tool to secure the insert against machining loads.

19. A cutting tool as claimed in claim 18 wherein the cutting blade is adjustably located along the ridge by means of a single screw threaded adjuster.

20. A cutting tool as claimed in claim 18 wherein the insert is mounted within a recess on the circumferential surface of the tool, and any ridge or ridges are provided by serrations on a side face of the recess.

21. A cutting tool as claimed in claim 20, wherein the insert is secured to said face by the head of a clamping screw or a clamp down plate.

22. A method of securing a polycrystalline diamond (PCD) material cutting blade in a cutting tool, the cutting blade having at least one cutting edge formed on the PCD face of the blade, wherein the cutting blade is provided with at least one groove within the second phase substrate, and the blade is clamped against a mutually inter-engageable ridge or ridges provided on the tool, so that the groove(s) and ridge(s) are mutually inter-engaged.

23. A method as claimed in claim 22 wherein the said at least one groove extends substantially normal with the cutting edge of the blade for the whole width of the blade, and the blade is adjustably mounted on the ridge or ridges by movement of the blade along the ridge(s) by adjuster means provided on the tool.

24. A method as claimed in claim 22 for securing a cutting blade having a plurality of cutting edges, wherein the blade edge can be changed or the blade changed, simply by removing the blade from the tool and relocating said blade, or another identical blade on the ridge(s), to provide a new cutting edge, with the mutually interengaging groove(s) and ridge(s) ensuring re-alignment of said cutting edge.
